(19) United States
(12) Patent Application Publication
(10) Pub. No.: US 2018/0120167 A1
(43) Pub. Date: May 3, 2018

(54) SMART MEAT THERMOMETER

(71) Applicants: Jeremy Adam Hammer, Kirkland, WA (US); James Andrew Hammer, Kirkland, WA (US)

(72) Inventors: Jeremy Adam Hammer, Kirkland, WA (US); James Andrew Hammer, Kirkland, WA (US)

(21) Appl. No.: 15/782,832

(22) Filed: Oct. 12, 2017

Related U.S. Application Data
(60) Provisional application No. 62/407,512, filed on Oct. 12, 2016.

(51) Int. Cl. G01K 3/00; G01K 1/02

(52) U.S. Cl. CPC G01K 3/005; G01K 13/00; G01K 1/024; G01K 1/026

(57) ABSTRACT

A temperature monitoring system is provided. The temperature monitoring system may include a sensor assembly and a base unit. The sensor assembly may include a probe, a cable portion, a probe plug, and a logic controller. The logic controller may be configured to receive a signal indicative of a temperature of a food item and convert the signal into a digital representation. The base unit may include a sensor interface coupled to the probe plug, and a controller. The controller may be configured to receive the digital representation from the logic controller via the sensor interface. The base unit may be configured to transmit the digital representation to a receiving entity.

### CROSS-REFERENCE TO RELATED APPLICATIONS

This application claims the benefit of U.S. Provisional Patent Application Ser. No. 62/407,512, filed Oct. 12, 2016, the entire disclosure of which is hereby incorporated herein by reference in its entirety.

### FIELD

Systems and methods for receiving sensor data, processing sensor data, and displaying sensor data are disclosed.

### BACKGROUND

Traditional meat thermometers and other sensors utilized in barbecuing, food smoking, and oven baking practices offer some flexibility in providing a user information about a cooking experience. However, such traditional sensors provide real-time information and make little to no use of past cooking experiences. Moreover, such traditional sensors lack the necessary hardware to take advantage of the developing connected device industries. Rather, such traditional sensors lack anytime and anywhere access.

### SUMMARY

Embodiments of the present disclosure are directed to systems and methods for receiving sensor data, processing sensor data, and displaying sensor data, in the oven baking, barbecuing, and food smoking contexts.

Embodiments in accordance with the present disclosure may be directed to a temperature monitoring system including a sensor assembly that includes a probe, a cable portion, a probe plug, and a logic controller, where the logic controller is configured to receive a signal indicative of a temperature of a food item and convert the signal into a digital representation. The cable portion may be between the probe plug and the logic controller. The base unit may include a sensor interface removeably and communicatively coupled to the probe plug, and a controller. The controller may be configured to receive the digital representation from the logic controller via the sensor interface, where the base unit is configured to transmit the digital representation to a receiving entity.

Embodiments in accordance with the present disclosure may be directed to a temperature monitoring system including a sensor assembly. The sensor assembly may include a probe, a cable portion, a probe plug, and a logic controller, the logic controller configured to receive a signal indicative of a temperature of a food item and convert the signal into a digital representation. The cable portion may be between the probe plug and the logic controller. The base unit may include a sensor interface removeably and communicatively coupled to the probe plug, and a controller, the controller configured to receive the digital representation from the logic controller via the sensor interface. The temperature monitoring system may include a remotely located computer-based entity configured to receive the digital representation from the logic controller and associate the received digital representation to a cooking session identifier.

Embodiments in accordance with the present disclosure may be directed to a method for associating temperature data with a cooking session, the method including: receiving from a base unit, a digital representation of a temperature associated with a food item, storing the digital representation, receiving from a remotely located mobile device, an indication to start a cooking session, creating a new cooking session identifier, and associating the digital representation of the temperature associated with the food item with the new cooking session identifier.

Additional features and advantages of embodiments of the present disclosure will become more readily apparent from the following description, particularly when taken together with the accompanying drawings.

### BRIEF DESCRIPTION OF THE DRAWINGS

FIG. 1 illustrates one or more hardware components of a smart meat thermometer system in accordance with embodiments of the present disclosure;

FIG. 2 illustrates additional details of a sensor assembly in accordance with embodiments of the present disclosure;

FIG. 3 depicts a block diagram of a base unit and probe system in accordance with embodiments of the present disclosure;

FIG. 4 illustrates additional details of additional probe assemblies in accordance with embodiments of the present disclosure;

FIG. 5 depicts aspects of a smart thermometer system in accordance with embodiments of the present disclosure;

FIG. 6 depicts aspects of a mobile device and/or a server in accordance with embodiments of the present disclosure;

FIG. 7 depicts additional details of one or more components of the base unit and data received and/or sent by such components in accordance with embodiments of the present disclosure;

FIG. 8 depicts additional details of data sent from a mobile device and received at a server of the smart thermometer system in accordance with embodiments of the present disclosure;

FIG. 9 depicts additional details related to a cooking session in accordance with embodiments of the present disclosure;

FIGS. 10A-F depict aspects related to starting and displaying information associated with a cooking session in accordance with embodiments of the present disclosure;

FIG. 11 depicts aspects related to providing information related to a past and/or present cooking session in accordance with embodiments of the present disclosure;

FIG. 12A-C depict additional aspects related to providing a user information related to a past and/or present cooking session in accordance with embodiments of the present disclosure;

FIG. 13 depicts additional details related to providing a user information related to past and/or present cooking sessions of another user in accordance with embodiments of the present disclosure;

FIG. 14 depicts one or more entity relationships between data in accordance with embodiments of the present disclosure;

FIG. 15 depicts a first process in accordance with embodiments of the present disclosure;

FIG. 16 depicts a second process in accordance with embodiments of the present disclosure;

FIG. 17 depicts a third process in accordance with embodiments of the present disclosure;

FIG. 18 depicts a fourth process in accordance with embodiments of the present disclosure;

FIG. 19 depicts a fifth process in accordance with embodiments of the present disclosure; and

FIG. 20 depicts a sixth process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Disclosed herein is a smart thermometer system that can alert you when your meat or food item temperature or the ambient temperature of your oven, smoker or grill fall outside the limits you set, or reach a target level. The smart thermometer system recognizes the altitude of your mobile device and suggests cooking time and temperature accordingly. The base unit is loaded with smart electronics that once paired with the WiFi system near your cooking equipment (e.g., your home WiFi system) communicates with an application running on a mobile device utilizing the internet and a server. As long as the mobile device has access to the internet, it can receive notifications from the base unit no matter how far away it is from the base unit. In instances were WiFi is not available, the smart thermometer system will communicate exclusively to the app on the mobile device, within a limited range (e.g., your campsite).

The smart meat thermometer system is specifically designed for use in BBQ grills, open grills, ovens, and smokers, but can be used in any situation were sensor data is needed. The smart thermometer system stores settings previously used before and allows a user to select them again from a user's history. The user can even share the details of your cooking sequence with friends or post them on social media.

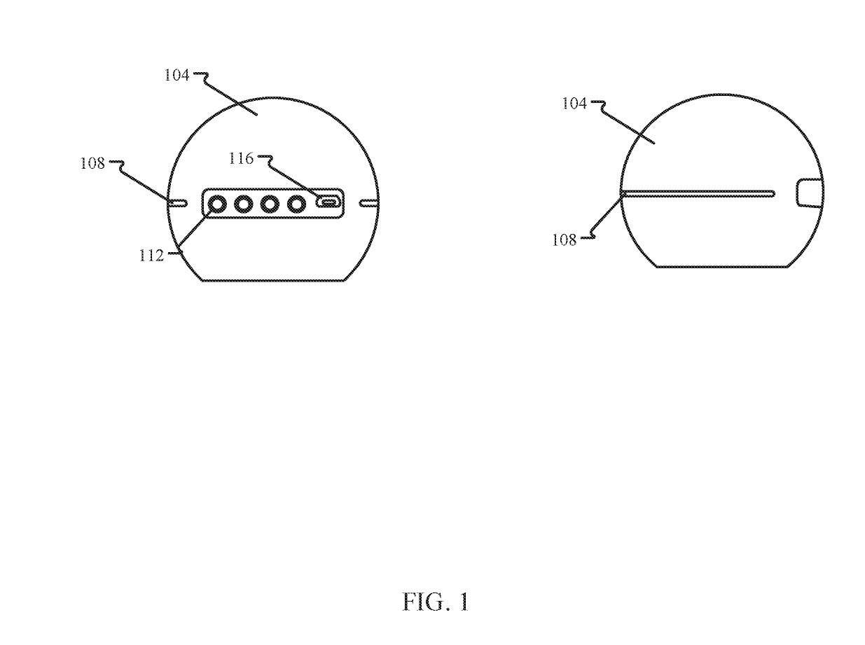

Referring initially to FIG. 1, details of one or more hardware components of a smart meat thermometer system are depicted in accordance with embodiments of the present disclosure. The base unit 104 of the smart thermometer system includes one or more sensor interfaces 112 for connecting one or more sensors, such as a thermometer, one or more power/data interfaces 116, and a status/display indicator, such as a light ring 108. As will be described, the sensor interface 112 may provide a sensor, such as a thermometer, connection to the base unit 104 such that measurements of one or more parameters, for example temperature, may be obtained. The power/data interface 116 may provide an interface for tethering and communicating with the base unit 104. Alternatively, or in addition, the power/data interface 116 may provide an interface for providing power to the base unit 104. The light ring 108 may generally indicate a status, such as an operating state of the base unit 104. The base unit 104 may act as an intermediary, taking one or more measurements received at the sensor interface 112, packaging the measurement into a transmittable format, and transmitting the measurement to a location that is remote from the base unit 104. More specifically, the base unit 104 may provide a means for obtaining a measurement from a sensor and providing the measurement to one or more locations.

The base unit 104 may be located outside of a cooking container, such as an oven, barbecue, smoker, and/or grill such that a sensor providing information related to a measurement of a food item and/or related to a cooking process, for example a temperature of the food item, may be provided to sensor interface 112 of the base unit 104. In accordance with embodiments of the present disclosure, processing of measurement data received at the sensor interface 112 prior to providing the measurement data to a location that is remote from the base unit 104 is minimized to reduce power consumption and extend an operating capacity of a portable power source, such as a battery and/or capacitor. Thus, extensive processing and manipulation of the measurement data is performed at a location remote to the base unit 104, such as at a dedicated server and/or service accessible via the internet and/or a cloud service.

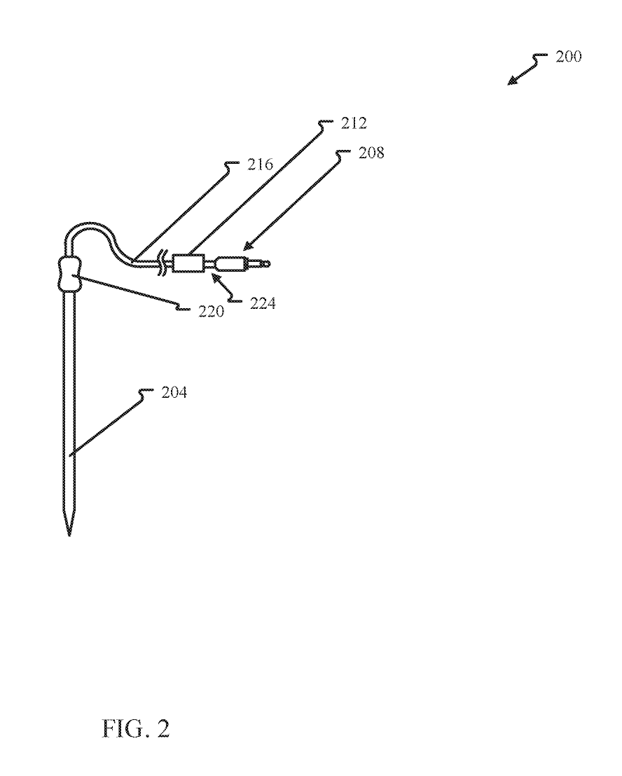

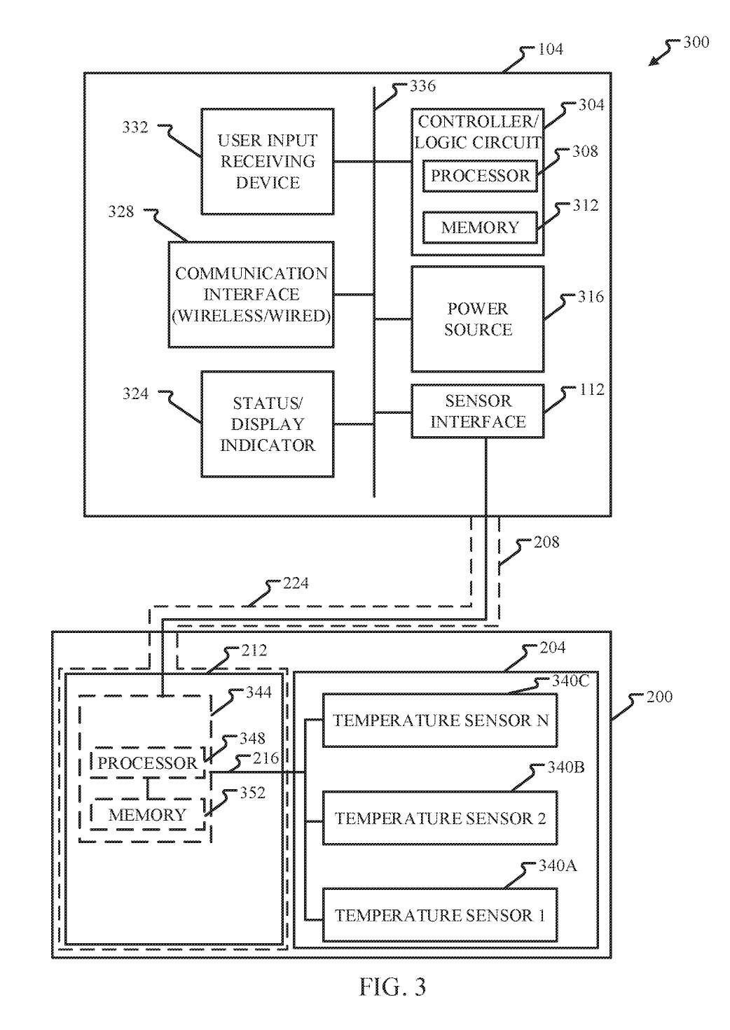

FIG. 2 depicts additional details of a sensor assembly in accordance with embodiments of the present disclosure. The sensor assembly, or probe assembly, may include a probe 204 and a probe cable plug 208 separated by a cable electronics/pcb section 212 and one or more cable portions 216. In accordance with embodiments of the present disclosure, the probe 204 may include a plurality of temperature sensors, whereby the probe cable plug 208 attaches the plurality of temperature sensors to the sensor interface 112. Thus, the probe 204 may be inserted into a food item to obtain a measurement of a temperature within the food item. Alternatively, or in addition, another temperature sensor included in the probe 204 may be located just outside of the food item and within the cooking container, allowing a measurement of a temperature within the cooking container (for example, ambient air temperature of the cooking container) to be obtained.

It should be appreciated that the sensor assembly may contain sensors other than sensors that measure temperature; for example, the probe 204 may comprise one or more sensors that provide a measurement of a parameter related to cooking one or more food items. Examples of such parameters include, but are not limited to, humidity, air density, food item density, food item size, food item texture, food item water content, and smoke density. Alternatively, or in addition, the probe assembly 200 may include one or more sensors that obtain a measurement related to a cooking process. As one non-limiting example, the probe assembly 200 may obtain a measurement related to a fuel flow rate, a state of a door, cover, or lid of a cooking container (for example, open or closed), a measurement related to a fill level of a pellet hopper of a smoker, and/or an ambient temperature outside of the cooking container (for example, the temperature of an environment in which the cooking container is located).

In accordance with embodiments of the present disclosure, and as previously discussed, the probe assembly 200 may obtain a measurement of a parameter relating to a food item and/or a cooking process. More specifically, the probe 204 may provide a voltage, current, and/or resistance measurement indicative of the measured parameter. For example, the probe 204 may provide a temperature dependent voltage indicative of a temperature of a first probe section. The first probe section may be a thermocouple, RTD, or similar temperature sensing device. The temperature dependent voltage may be an analog signal. Accordingly, the voltage signal provided by the probe 204 may be received at the cable electronics/pcb section 212 whereby the voltage signal is converted into a digital format and assembled into a format to be provided to the base unit 104 via the probe cable plug 208 and the sensor interface 112. Of course, an analog signal related to current and/or resistance may be provided to the cable electronics/pcb section 212 in a similar manner. Such assembled format may include the probe type and/or identity the measured parameter. In accordance with embodiments of the present disclosure, the assembled format may include the digitized value of the measured parameter.

In some embodiments, where the probe 204 includes multiple sensing portions, an analog signal of each sensing portion may be provided to the cable electronics/pcb section 212, where the analog signal is converted into a digital format and assembled into a format to be provided to the base unit 104 via the probe cable plug 208 and the sensor interface 112. Thus, the format may include the measurements related to each of the sensing portions of the probe. In accordance with embodiments of the present disclosure, the cable electronics/pcb section 212 may sample the one or more probe sensing portion at a desired sample rate. Such desired sample rate may be configured by the base unit 104.

The probe assembly 200 may include an overmold 220 where the probe 204 may transition into the cable portion 216. The probe 204, probe overmold 220, and cable electronics/pcb section 212 may withstand high temperatures of the cooking container. For example, the cooking container may reach temperatures in excess of 550° F.; the probe 204, probe overmold 220, and cable electronics/pcb section 212 may withstand such temperatures. In accordance with embodiments of the present disclosure, the probe 204 may be of a specific shape as to be inserted into a food item, such as meat.

Referring to FIG. 3, additional details of the base unit and probe system 300 are depicted in accordance with embodiments of the present disclosure. As previously discussed, the base unit and probe system 300 includes the base unit 104 and the probe assembly 200. The base unit 104 may include, but is not limited to, controller/logic circuit 304 which includes a processor 308 and a memory 312, a power source 316, the sensor interface 112, a status/display indicator 324 (for example, the light ring 108), a communication interface (wired and/or wireless) 328, and a user input receiving device 332. Each of the controller/logic circuit 304, power source 316, sensor interface 112, status/display indicator 324, communication interface 328, and user input receiving device 332 may be coupled to one another via the bus 336.

The processor 308 executes instructions contained within memory 312. Accordingly, the processor 308 may be implemented as any suitable type of microprocessor or similar type of processing chip, such as any general-purpose programmable processor, digital signal processor (DSP), or controller for executing application programming contained within memory 312. Alternatively, or in addition, the processor 308 and memory 312 may be replaced or augmented with an application specific integrated circuit (ASIC), a programmable logic device (PLD), or a field programmable gate array (FPGA).

The memory 312 generally comprises software routines facilitating, in operation, pre-determined functionality of the base unit 104. The memory 312 may be implemented using various types of electronic memory generally including at least one array of non-volatile memory cells (e.g., Erasable Programmable Read Only Memory (EPROM) cells or flash memory cells, etc.) The memory 312 may also include at least one array of Dynamic Random Access Memory (DRAM) cells. The content of the DRAM cells may be pre-programmed and write-protected thereafter, whereas other portions of the memory may selectively be modified or erased. The memory 312 may be used for either permanent data storage or temporary data storage.

The communication interface(s) 328 may be capable of supporting communications and/or data transfers over a wireless network. Alternatively, or in addition, the communications interface 328 may comprise a Wi-Fi, BLUETOOTH™, WiMAX, infrared, NFC, and/or other wireless communications links. The communication interface 328 may be associated with one or more shared or a dedicated antenna.

The power source 316 may be any type of power source that provides power to the one or more components of the base unit 104 as well as the probe 204, or a plurality of probes 204. The status/display indicator 324 may display an indication as to whether or not a desired cooking temperature has been reached, a cooking time has been reached, and/or whether or not a food item is finished cooking. Alternatively, or in addition, the status/display indicator 324 may indicate a connection state of the base unit 104 with a mobile device and/or with a Wi-Fi connection. In some embodiments, the status/display indicator 324 may indicate whether the base unit 104 is powered on. The status/display indicator 324 may illuminate one or more colored LED lights as such indication, the status/display indicator 324 may be at least partially implemented utilizing the light ring 108; that is the light ring 108 may be illuminated with one or more colors in accordance with a cooking time having been reached and/or whether or not a food item has finished cooking.

The sensor interface 112 may generally provide a jack for connecting one or more probes 204 such that information and/or data from the probe 204 may be received at the controller/logic circuit 304 via the communication bus 336. A user input receiving device 332 may be provided to generally power on/off the base unit 104, reset the base unit 104, and/or provide input, such as but not limited to a coded input, to the base unit 104.

Referring again to FIG. 3, the probe assembly 200 may be connected to the base unit 104 via one or more cables 224 having a probe cable plug 208. The cable 224 may include the cable electronics/PCB portion 212. The cable electronics/pcb section 212 may include a controller/logic circuit 344. The cable electronics/pcb section 212 may receive power from the power source 316. The controller/logic circuit 344 may include a processor 348 and a memory 352. The controller/logic circuit 344 may receive information, such as temperature data in the form of an analog signal, such as a voltage, current, and/or an encoded signal for example, from one or more sensors, such as the temperature sensors 340A-340C, process the temperature data, and provide such data to the base unit 104 via the cable 224 and sensor interface 112. Accordingly, the controller/logic circuit 344 may provide necessary information to the base unit 104 to allow the base unit 104 to determine what kind of probe the probe 204 is and/or what section of the probe a measurement is associated with. Since the probe 204 may be designed to be inserted into a meat item for example, the sensor 340A may measure a temperature within the meat item as the meat item cooks while the sensor 340B may measure an ambient temperature associated with the cooking meat item. For example, the sensor 340B may measure the temperature within a BBQ grill or smoker or other cooking container. Each of the temperature sensors 340A-C may be a thermocouple, RTD, or similar temperature sensing device. In some embodiment, the probe 204 may include multiple temperature sensors 340 to measure a temperature inside a cooking meat item for example. Thus, a user may know that the outside portion of the cooking meat item is a first temperature and an inside portion of the cooking meat item is another temperature.

The probe may include sensor(s) 340A-C, where a first sensor section 340A may correspond to a first portion of the probe 204 and a second sensor section 340B may correspond to a second portion of the probe 204. Accordingly, the controller/logic circuit 344 may receive a measured quantity for each of the first and second portion, convert the received measured quantity into respective first and second digital formats, and tag each of the first and second digital formats with respective probe identification information and/or probe sensor section identification information. Such first and second digital formats together with the respective probe identification information and/or probe sensor section identification information may then be provided to the base unit 104 via the sensor interface 112 and probe cable plug 208. In accordance with embodiments of the present disclosure, the first and second digital formats may be provided to the base unit 104 via the sensor interface 112 and probe cable plug 208 utilizing a structured format, where the structured format indicates a position of the probe section for which a measurement is obtained. In such an instance, probe identification information may be communicated to the base unit 104 when the probe assembly 200 is connected to the base unit 104 and/or each time data is transmitted to the base unit 104. Multiple probe assemblies 200 may be connected to the base unit 104 such that many different cooking items, for example ribs, brisket, and chicken may be monitored at a same time.

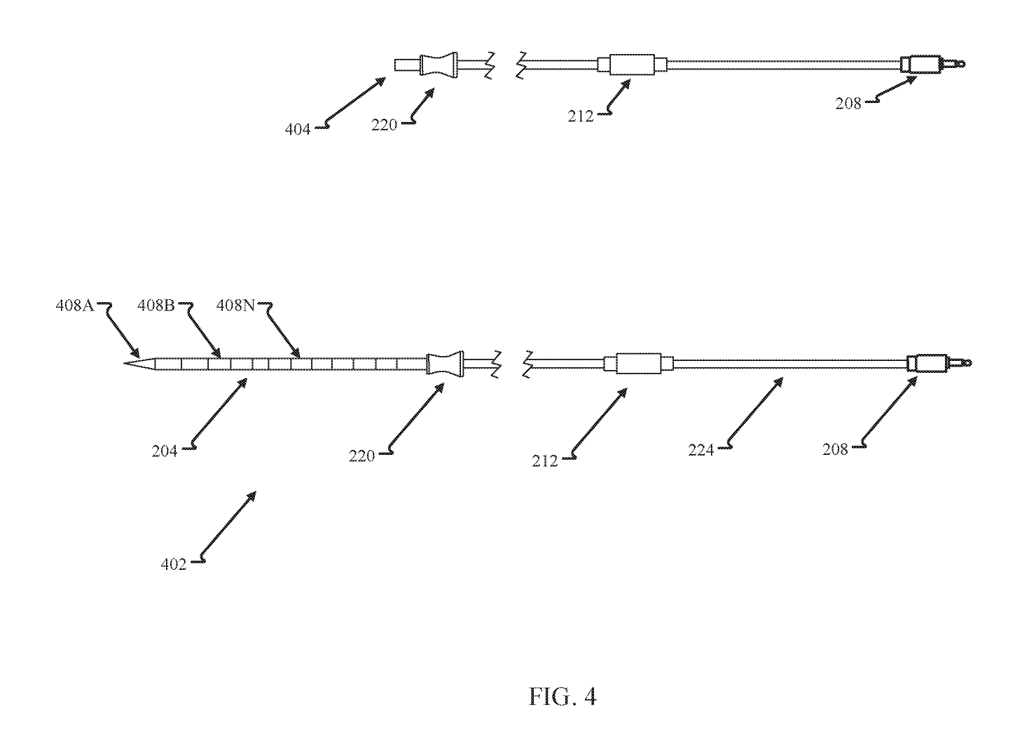

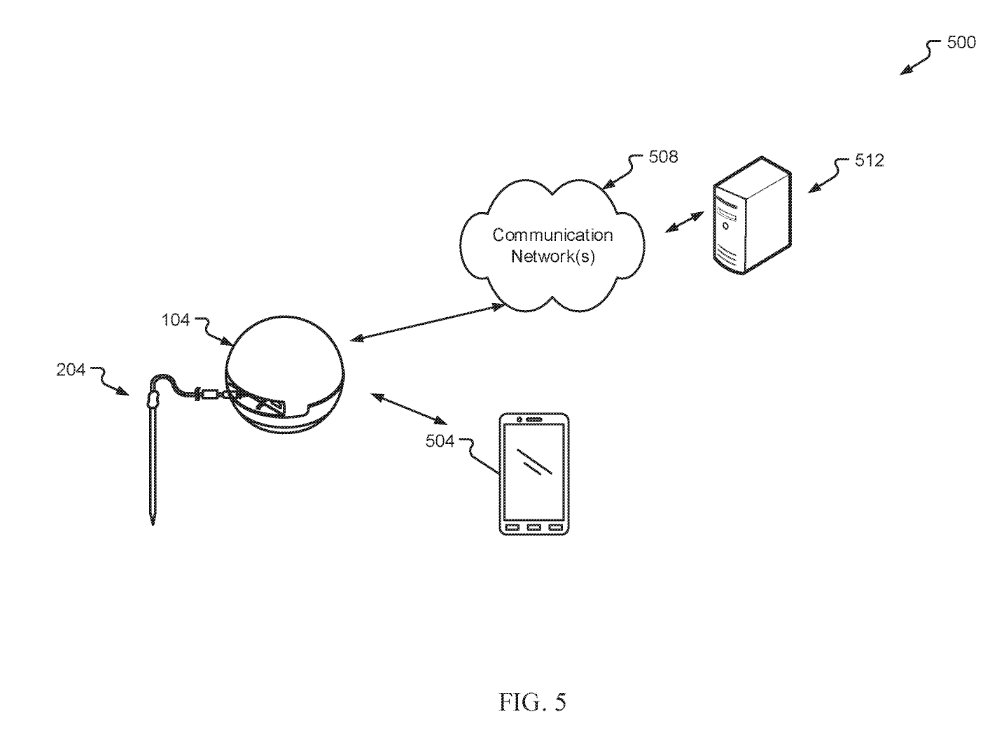

FIG. 4 depicts additional details of additional probe assemblies in accordance with embodiments of the present disclosure. More specifically, a smoke density sensor 404 is depicted. The smoke density sensor may include a sensor specifically directed to measuring an amount or density of smoke within a cooking container, such as a smoker and/or oven. The smoke density sensor may be coupled to a cable section utilizing the overmold 220; a signal indicative of the measured amount of smoke may be received at the cable electronics/pcb section 212, converted into a digital format, and sent to the base unit 104 via the probe cable plug 208 and sensor interface 112.

In accordance with embodiments of the present disclosure, FIG. 4 depicts a temperature probe 402 having multiple temperature sensing portions 408A-408N. As previously discussed with respect to FIG. 3, each of the temperature sensing portions 408A-408N may provide an analog sensor indicative of a temperature to the cable electronics/pcb section 212, where each of the temperatures associated with the corresponding probe sensing portion 408 is provided to the base unit 104. Each of the temperature sensing portions 408 may correspond to a respective sensor 340 as previously described.

As depicted in FIG. 5, and in accordance with embodiments of the present disclosure, the base unit 104 may communicate with a mobile device 504 and server 512 to receive configuration settings and provide alerts. That is, the base unit 104 may receive configurations settings for setting alert options based on one or more monitored cooking items. For example, the base unit 104 may send an alert to the mobile device 504 when a meat item within a BBQ or smoker reaches a first temperature. As another example, the base unit 104 may send an alert to the mobile device 504 when the temperature within (e.g., ambient temperature) a BBQ or smoker reaches a first temperature. In some embodiments, the base unit 104 may provide information to the server 512 and the server 512 provides such alerts to the mobile device 504. Thus, the base unit 104 and the mobile device 504 may be on different local area networks. Further, the mobile device 504, which may be a smartphone, laptop, watch, wearable, desktop, or similar computing device, may run one or more applications (apps) and provide configuration settings such that appropriate alarm settings are configured. The mobile device 504 may be paired with the base unit 104.

Alternatively, or in addition, the base unit 104 may provide a means for providing one or more measured parameters associated with a sensor assembly 204, such as temperature measurements, to the server 512. As one example, the base unit 104 may associate such measured parameters with a profile and/or cooking session, and transmit such measured parameters to the server 512 via a communication network 508. The server 512 may then associate or otherwise save the measured parameters to a profile, such as a user profile.

Alternatively, or in addition, the base unit 104 may transmit the measured parameters together with base unit identifying information. Thus, a base unit 104 may be associated with a profile, such as a user profile, and measured parameters transmitted from the base unit 104 may be associated with the profile via the base unit identifying information. In some instances, the base unit 104 continually transmits temperature data to the server 512; if a cooking session, for example when a user would like to log and/or view measurement parameters and/or associate measured parameter cooking information with one or more recipes, has not been initiated, the measured parameters are simply discarded. In some instances, the base unit 104 may receive a communication from the server 512 indicating that a cooking session has been initiated; in response to the received communication, the base unit 104 may transmit measured parameters, such as temperature data, to the server 512. The server 512 may receive the measured parameters, associate the measured parameters with a profile, such as a user profile, process the measured parameters, and then transmit processed measured parameter information to the mobile device 504 in a push, pull, or other manner. Such information may then be displayed at the mobile device 504 via one or more applications, or apps. Thus, apart from an initial setup process, the base unit 104 and the mobile device 504 may not directly communicate with one another. That is, when measured parameters, such as temperature data received at the base unit 104 via the probe assembly 200, are transmitted to the server 512. The server 512 may then store the measured parameters and transmit a copy or data indicative of the measured parameters to the server 504. Thus, the mobile device 504 may be connected to a first network, such as a first local area network or cellular network, while the base unit 104 is connected to a second network, such as a second local area network. Though the server 512 may bridge the base unit 104 and mobile device 504 together, the mobile device 504 and the base unit 104 do not communicate with one another.

The communication network 508 may comprise any type of known communication medium or collection of communication media and may use any type of known protocols to transport messages between endpoints. The communication network 508 is generally a wireless communication network employing one or more wireless communication technologies; however, the communication network 508 may include one or more wired components and may implement one or more wired communication technologies. The Internet is an example of the communication network 508 that constitutes an Internet Protocol (IP) network consisting of many computers, computing networks, and other communication devices located all over the world, which are connected through many networked systems and other means. The communication network 508 may include two or more disparate sections, such as a first network section and/or first local area network and a second network section and/or second local area network. The first and second network sections and/or local area networks may be communicatively coupled to one another.

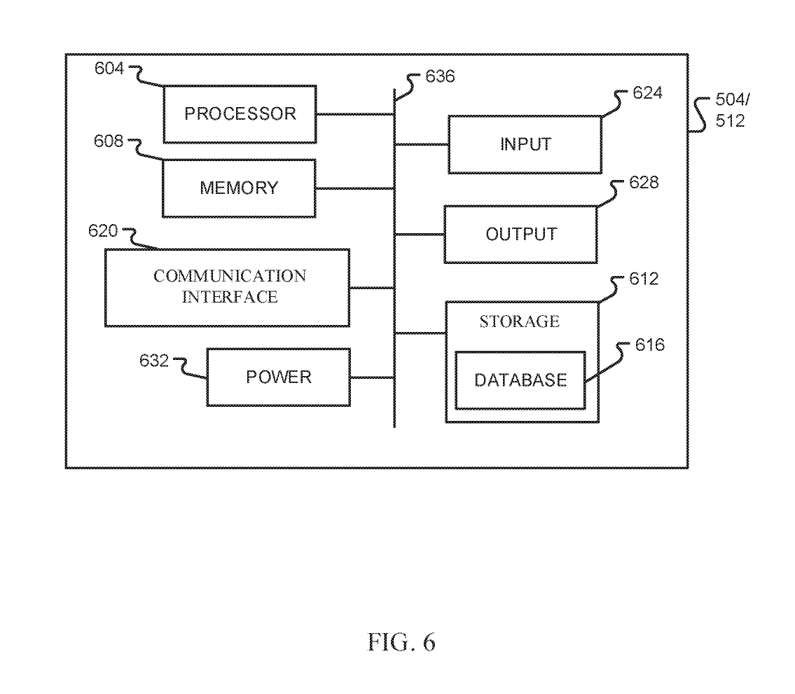

FIG. 6 depicts additional details of the mobile device 504 and/or the server 512 in accordance with embodiments of the present disclosure. The mobile device 504 and/or server 512 may include a processor 604, a memory 608, storage 612 including one or more databases 616, a communication interface 620, and a power source 632 coupled to one another in some manner via a bus 636. The processor 604 executes instructions contained within memory 608. Accordingly, the processor 608 may be implemented as any suitable type of microprocessor or similar type of processing chip, such as any general-purpose programmable processor, digital signal processor (DSP), or controller for executing application programming contained within memory 608. Alternatively, or in addition, the processor 604 and memory 608 may be replaced or augmented with an application specific integrated circuit (ASIC), a programmable logic device (PLD), or a field programmable gate array (FPGA).

The memory 608 generally comprises software routines facilitating, in operation, pre-determined functionality of the mobile device 504 and/or server 512. The memory 608 may be implemented using various types of electronic memory generally including at least one array of non-volatile memory cells (e.g., Erasable Programmable Read Only Memory (EPROM) cells or flash memory cells, etc.) The memory 608 may also include at least one array of Dynamic Random Access Memory (DRAM) cells. The content of the DRAM cells may be pre-programmed and write-protected thereafter, whereas other portions of the memory may selectively be modified or erased. The memory 608 may be used for either permanent data storage or temporary data storage.

The communication interface(s) 620 may be capable of supporting communications and/or data transfers over a wireless and/or wired network. Alternatively, or in addition, the communications interface 620 may comprise a Wi-Fi, BLUETOOTH™, WiMAX, infrared, NFC, and/or other wireless communications links. The communication interface 620 may be associated with one or more shared or a dedicated antenna and may be capable of communicating via the communication network 508.

The power source 632 may be any type of power source that provides power to the one or more components of the mobile device 504 and/or server 512. The input(s) 624 may provide one or more means of interacting with and/or configuring user configurable items to the mobile device 504 and/or server 512, such as a keyboard and a pointing device. The output(s) 628 may be a display, speaker, and/or printer. Alternatively, or in addition, the user input 624 and the user output 628 may be combined into one device, such as a touch screen display. The database 616 may include temperature measurement information and/or user profile information as will be discussed.

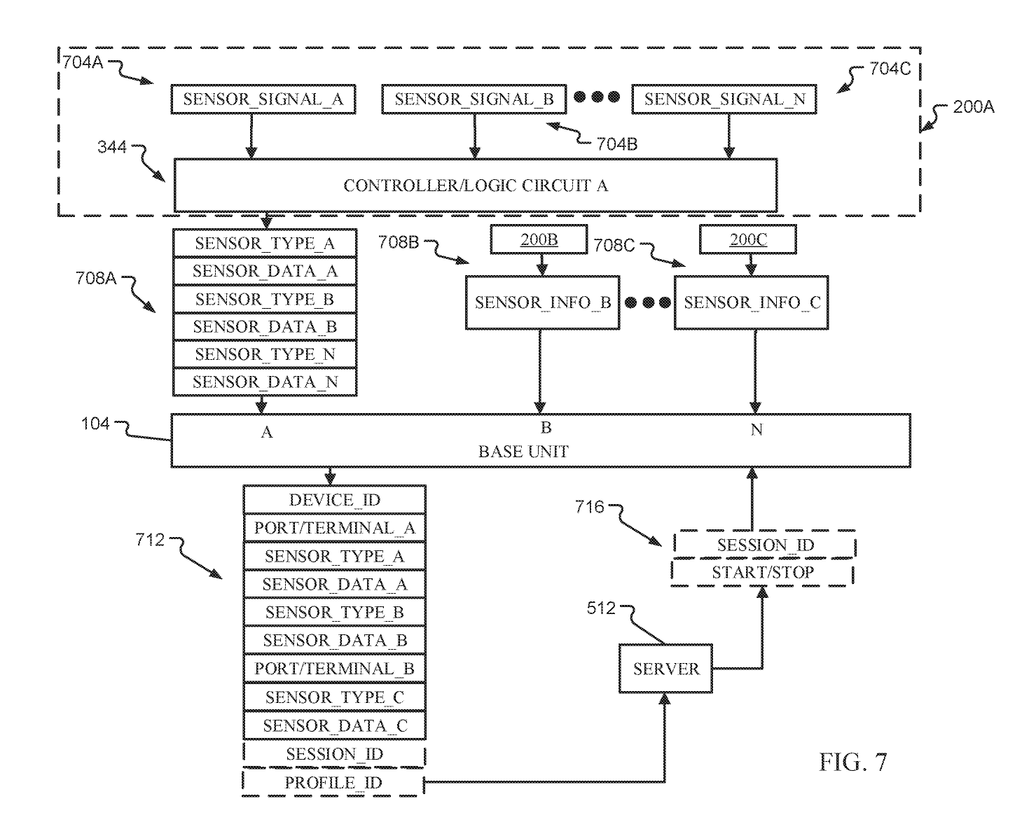

FIG. 7 depicts additional details of one or more components of the base unit 104 and data received and/or sent by such components in accordance with embodiments of the present disclosure. That is, a signal 704A, such as an analog signal including but not limited to a voltage and/or current, may be received at a controller/logic circuit 344 of a probe assembly 200. As previously described, the analog signal may be indicative of a temperature measurement or other measured parameter associated with a food item and/or a cooking process. Moreover, the probe assembly 200 may include a plurality of sensor portions 408 such that another signal (for example, 704B and/or 704C) indicative of a measured parameter is received at the controller/logic circuit 344 of the same probe assembly 200. The controller/logic circuit 344 may convert the measured parameter into a digital quantity representative of the respective measured quantity. For example, the controller/logic circuit 344 may convert an analog measured amount into a digital form. In some embodiments, the controller/logic circuit 344 may tag or otherwise associate the sensor type with the converted digital quantity.

As depicted in FIG. 7, where a plurality of sensor portions 408 are included in a sensor, such as a probe 204 of probe assembly 200A, sensor information 708 may be indicative of a data structure that includes the sensor type and/or the data associated with the sensor. For example, the SENSOR_TYPE_A may be a value indicating that the sensor reading 704A and 704B is from a thermometer having two sensing portions, where the SENSOR_DATA_A indicates a measured parameter of the first sensing portion is 225° F. and the measured parameter SENSOR_DATA_B of the second sensing portion is 325° F. Alternatively, or in addition, the SENSOR_TYPE_A may be a value indicating that the sensor reading 704A is from a first thermometer portion and has a value of SENSOR_DATA_A=225° F. while the SENSOR_TYPE_B may be a value indicating that the sensor reading 704B is from a second thermometer portion of the same thermometer and has a value of SENSOR_DATA_B=325° F. Thus, not all depicted components of the data structure 708A are required.

Moreover, as the base unit 104 may include multiple sensor interfaces 112 for receiving multiple probe assemblies 200A-C, a different controller/logic circuit 344 may provide different sensor information 708B and/or 708C to the base unit 104. Thus, the base unit 104 may tag or otherwise associate the sensor interface 112 port or jack with the sensor information 708A-C. Alternatively, or in addition, as a user may be utilizing multiple base units 104, the base unit 104 may provide the sensor information 708 in an assembled format and/or data structure that includes a DEVICE_ID identifying the base unit 104, such as with a unique identifier, and/or a PORT/TERMINAL ID identifying a specific port or jack of the sensor interface 112 in which the probe assembly 200 may be connected. Thus, as depicted in FIG. 7, the base unit 104 may produce an assembled format and/or data structure 712 including the DEVICE_ID, PORT/TERMINAL ID, such as PORT/TERMINAL_A, and the sensor information 708A. In an instance where another sensor assembly 200B is connected to the base unit 104, the assembled format and/or data structure 712 may include PORT/TERMINAL_B and the sensor information 708B. In instances where another sensor assembly 200C is connected to the base unit 104, the assembled format and/or data structure 712 may include PORT/TERMINAL_C and the sensor information 708C. In some instances, where the controller/logic circuit 344 receives an indication from the server 512 that a cooking session is to be associated with the assembled format and/or data structure 712, the assembled format and/or data structure 712 may include a SESSION_ID, identifying the cooking session such that the server 512 may associate the sensor information 708 with a profile, such as a user profile. The base unit 104 may transmit the assembled format and/or data structure 712 to the server 512.

The base unit 104 may transmit the assembled format and/or data structure 712 to the server 512 based on how often a user looks at the application running on the mobile device 504. As an example, the application running on the mobile device 504 may determine that a user is viewing the application and cause a notification to be sent to the server 512; the server 512 may then send an indication to the base unit 104 to cause the base unit 104 to transmit the latest assembled format and/or data structure 712. Alternatively, or in addition, the base unit 104 may transmit the assembled format and/or data structure 712 at a predetermined sample rate or frequency; however, the server 512 may send information to the mobile device 504 based on how often the user looks at the application running on the mobile device 504.

Moreover over, the application running on the mobile device 504 may cause the base unit 104 to adjust the time interval between temperature samples based on how long is left to cook. For instance, if there is 16 hours left to smoke a brisket, a user would not need the temperature or sensor information every second, instead the mobile device 504 may indicate to the base unit 104 via the server 512 to sample every 30 seconds or so. If the item that is cooking is a steak however, 30 sampling intervals may overcook the meat, so once a second is more useful. The sampling interval may also change depending on how far along the cooking is. In a 16-hour smoke, a user might want to have a faster sample interval near the end when it is close to being done. If the application is running on the mobile device 504 for example, more updates may be provided. Or the amount of updates, e.g. interval, may be dependent on the type of food being cooked. For example, a pork shoulder that takes 12 hours to cook may have a longer interval at the beginning than at the end. Fish may have very short intervals because fish tends to cook faster.

In instances where the server 512 instructs the base unit 104 to start sending the assembled format and/or data structure 712, the server 512 may send a start/stop indication and/or a SESSION_ID 716, identifying a cooking session.

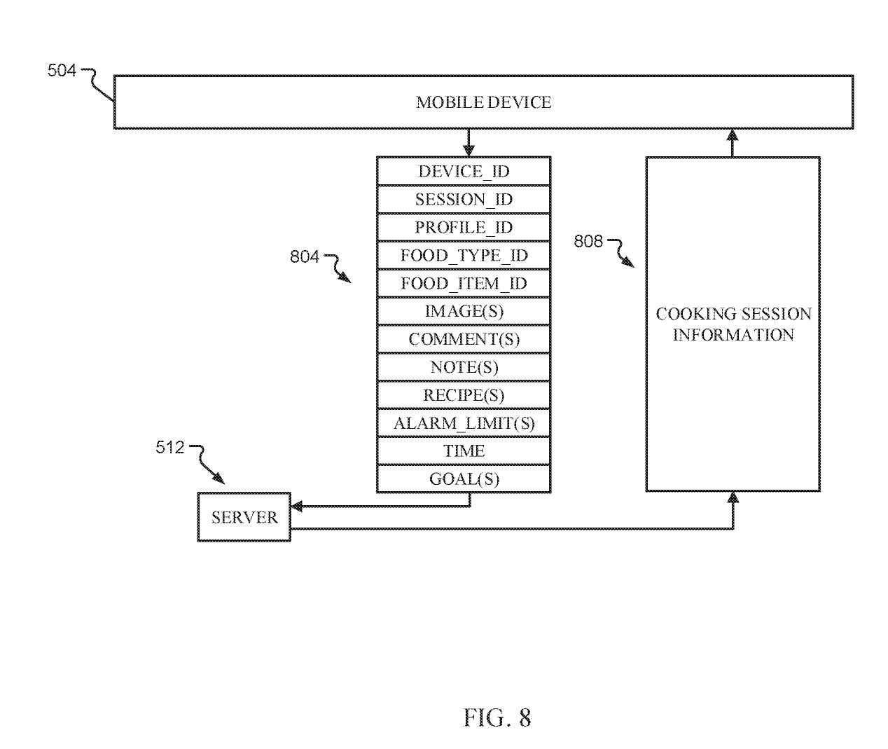

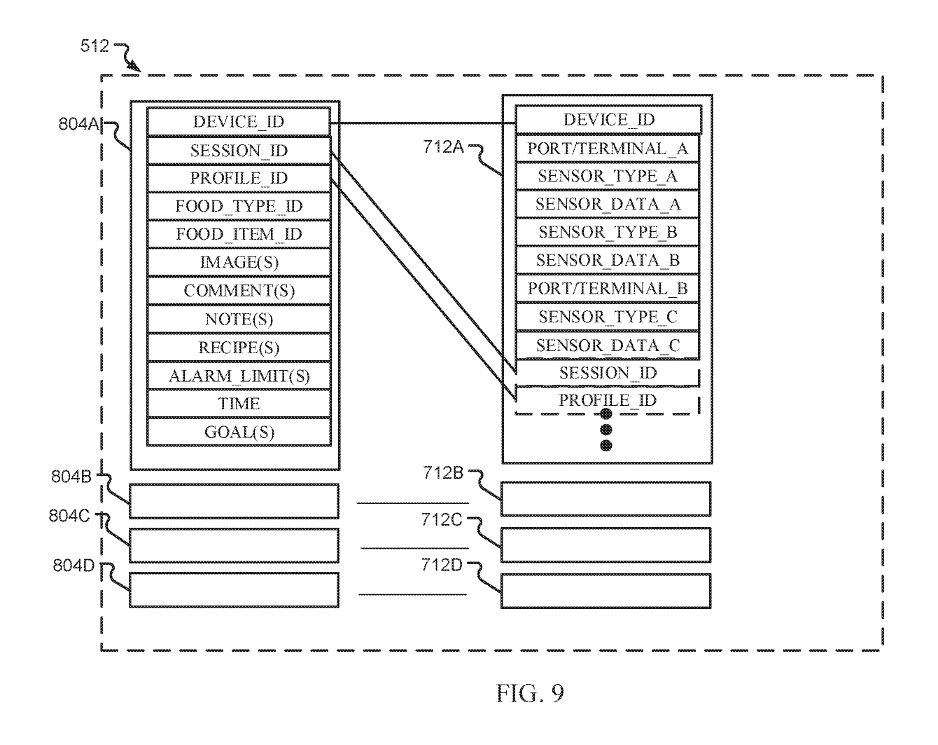

In accordance with embodiments of the present disclosure and as depicted in FIG. 8, the mobile device 504 may provide, via an application (app) or otherwise, parameters related to a cooking session and/or cooking experience. That is, if a user wishes to log and/or record sensor information from the base unit 104 associated with the one or more probe assemblies 200, the user, using the mobile device 504, may cause the mobile device 504 to transmit mobile device information 804 to the server 512. The information received from the mobile device 804 may include one or more of the DEVICE_ID identifying the base unit 104, a new SESSION_ID, identifying the new cooking session, user profile information PROFILE_ID, as well as cooking session information, such as a type of food being cooked, a specific food item, an image of the food item, comments and/or notes related to the preparation and/or consumption of the food item, one or more recipes associated with the food item, and cooking alarm limits (such as time and temperature) and/or desired temperature goals. Alternatively, or in addition, the information received from the mobile device may cause the server 512 to create a new Session_ID. Moreover, in instances where sensors providing a measurement of an item related to a cooking process are needed, such as an amount of smoke pellets in a hopper, an alarm limit may be set such that if the amount of smoke pellets is low or approaching zero, the user may be notified via the mobile device 504. The information received from the mobile device 804 may be a data structure and/or consist of multiple data structures. In addition to sending the information received from the mobile device 804, the mobile device 504 may receive cooking session information 808 for a cooking session currently in process, for a cooking session previously completed, and/or for another user's cooking session as will be described below.

In accordance with embodiments of the present disclosure and as depicted in FIG. 9, the server 512, having received the assembled format and/or data structure 712A for a specific cooking session and the information received from the mobile device 804A for a specific cooking session, may associate the two data structures with one another. That is, one or more of the PROFILE_ID, DEVICE_ID, and/or SESSION_ID may be utilized to associate the assembled format and/or data structure 712 that includes sensor related information about a cooking session to the information received from the mobile device 804. Accordingly, as the assembled format and/or data structure 712 is transmitted in real-time from the base unit 104 to the server 512, the server 512 may associate such information to the information received from the mobile device 804 and store such information. At the conclusion of the cooking session, the sensor information and the information received from the mobile device 804 may be available for future retrieval.

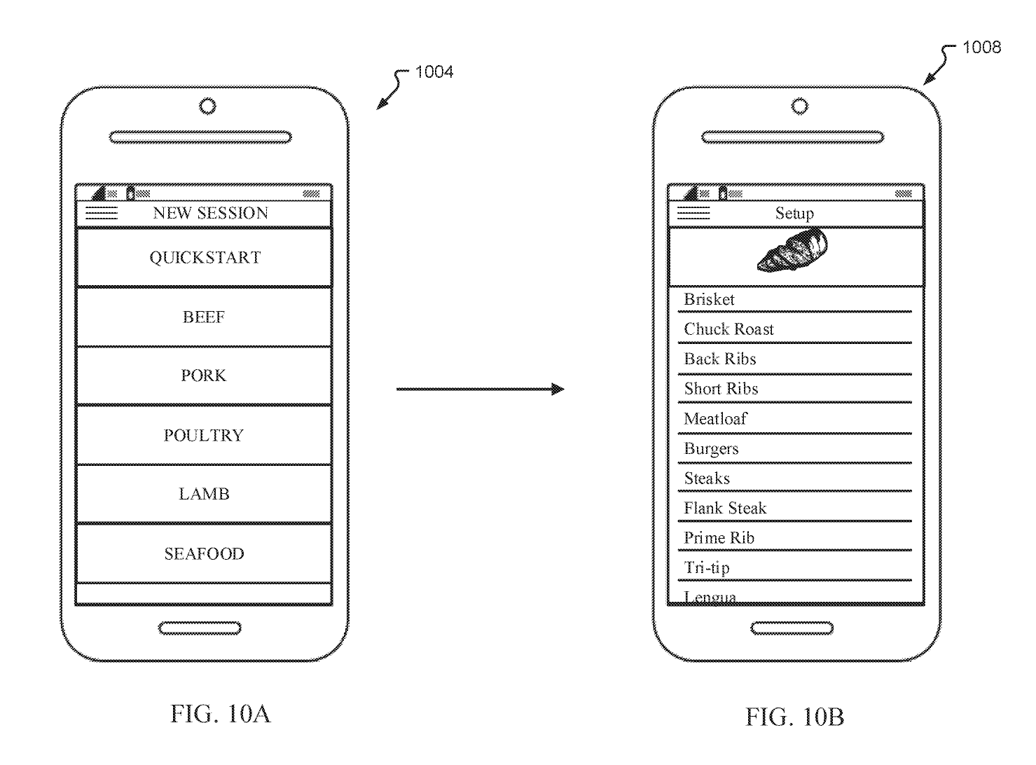

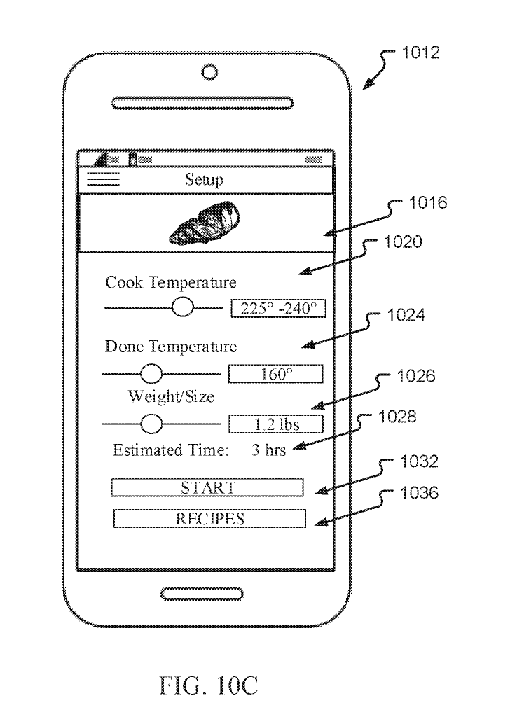

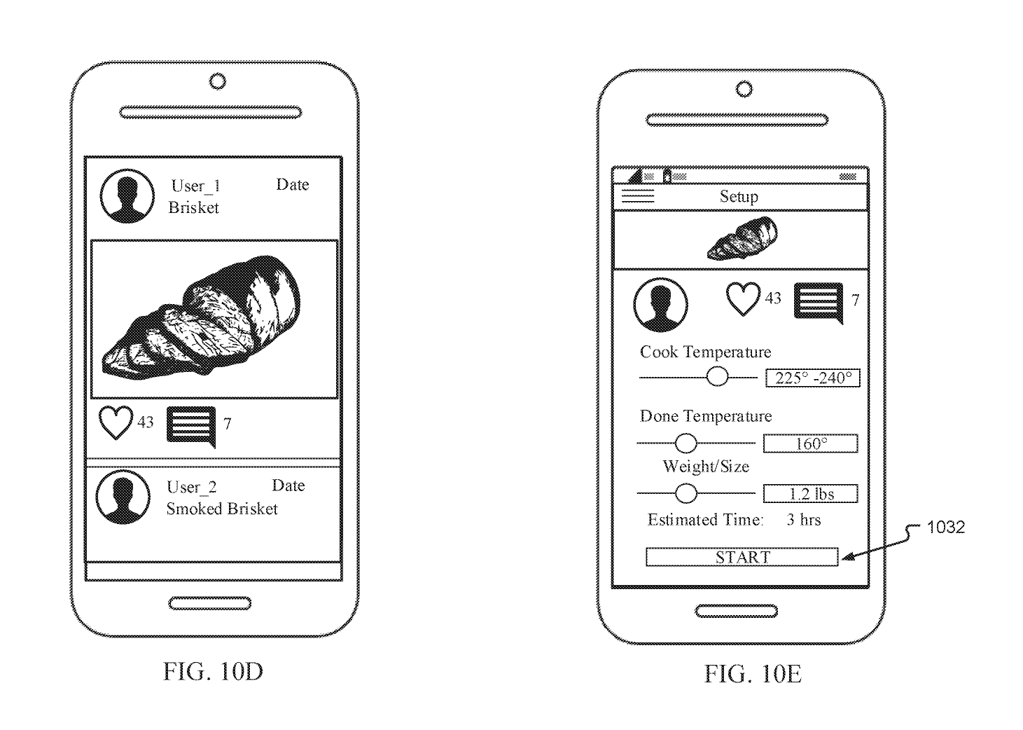

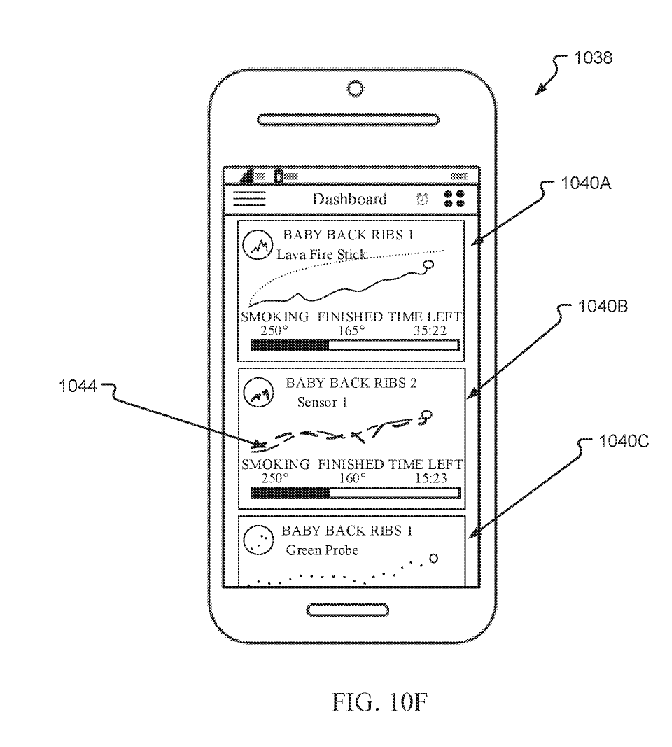

FIGS. 10A-F depict aspects related to starting and displaying information associated with a cooking session in accordance with embodiments of the present disclosure. That is, the mobile device 504 may receive cooking session information 808 from the server 512 and display a first user interface display 1004 upon the initiation of a cooking session. The first user interface display 1004 may ask a user to select one of a quickstart option and/or a type of meat or food being cooked. Upon selecting the type of meat or food being cooked the mobile device 504 may then prompt the user to make a further selection of a food subtype at the second user interface display 1008. For example, if a user were to select Beef at the first user interface display 1004, the user may then be presented with the second user interface display 1008 showing food subtypes. Upon selecting a food subtype at the second user interface display 1008, the third user interface 1012 may be displayed. The third user interface 1012 may include an image 1016 of the food subtype being cooked, a recommended cooking temperature 1020 which may be adjusted with a slider, and a recommended finishing or done temperature 1024 which may also be adjusted with a slider. The third user interface 1012 may further display an estimated cook time 1028. Of course, for differing types of food as well as food subtypes, the third user interface 1012 may include more or less configurable items. For example, a weight/size of the food item being cooked may affect the estimated cook time 1028; accordingly, the third user interface 1012 may include an option 1026 to select a weight/size of the food item being cooked. Furthermore, a user may be able to view recipes and/or other preparation methods associated with the food item utilizing the recipe button 1036. As one example, a user interface display illustrated in FIG. 10D may be displayed depicting various recipes for the food item and submitted by other users. Upon selecting one of the recipes, for example as illustrated in FIG. 10D, the user may be provided with the user interface as depicted in FIG. 10E, where the recommended cooking temperature and finishing temperature for the selected recipe as provided by the other user is displayed. Upon selecting start 1032, at either the user interface depicted in FIG. 10E or at the third user interface 1012, a fourth user interface display 1038 may be displayed, as depicted in FIG. 10F.

The fourth user interface display 1038 may depict one or more sensor data summary displays 1040A-C, where sensor information for one or more probe assemblies 200 is depicted. That is, a first sensor data summary display 1040A may be associated with a first probe assembly 200A, where temperature information for first and second sections 408A and 408N is displayed. For example, the solid temperature line may generally depict a temperature of a food item while the dotted temperature line may generally depict a temperature of a cooking container, e.g., the temperature of the smoker, oven, barbecue or otherwise.

In some embodiments, the different probe assemblies 200 based on the sensor interface 112 may be configured with a specific user-friendly name, such as “Lava Fire Stick” for probe assembly 200A at a first port or jack of the sensor interface 112 and “Sensor 1” for probe assembly 200B at a second port or jack of the sensor interface 112. Moreover, each of the probe assemblies 200 may be associated with the same or different food item, as depicted in the sensor data summary display 1040C. Additional information, such as one or more configured parameters from one or more of the first user interface display to the third user interface display may be depicted.

Each of the sensor data summary display may include an estimated “Time Left” parameter. The time left parameter may be calculated in a manner similar to that disclosed in U.S. Patent Publication Number 2016/0377490, the contents of which are herein incorporated by reference in their entirety for all that it teaches and for all purposes. In accordance with embodiments of the present disclosure, the “Time Left” may include an amount of time left and/or a predicted time of day done indication. For example, “Time Left” may correspond to the food item that is cooking will be finished at 6:00 PM instead of it will be ready within a specific amount of time. Moreover, the estimated time may or may not include an amount of time for the cooking item to rest.

Moreover, the application running on the mobile device 504 may receive an indication from the server 512 alerting a user to take certain food items off the grill/out of the smoker to allow for a predicted rise in temperature while the food item rests. Such an item may be included in one or more parameter settings of the third user interface display 1012 for example.

In accordance with embodiments of the present disclosure, where a user may have selected another user's recipe to follow, for example at FIG. 10D, a ghost profile 1044 may be displayed. For example, if an item has been cooked in the past and turned out really good, the temperature graph 1044 of the cooked item over time for the previously cooked item and the graph of meat over time for the currently cooking item (e.g., the dashed line in sensor data summary display 1040B) may be displayed such that a user can use the previously graphed temperature profile as a guide. Such ghost profile may also be created for the ambient air temperature or other sensors. Moreover, social media integration may allow a user to share the ghost profile such that another user can use the ghost profile and/or allow a user to sell the ghost profile at a storefront.

Upon meeting one or more parameters, such as a done temperature and/or the expiration of an amount of time that is left cooking, the server 512 may cause the mobile device 504 to announce and/or display an alert. It should be appreciated that data illustrated in FIGS. 10A-F may be provided to the mobile device 504 from the server 512 as cooking session information 808. In instances where the quickstart option is selected as displayed at first user interface display 1004, the user of the mobile device 504 may have the ability to modify and/or edit the food item, food type, and preferred cooking conditions at a later point in time.

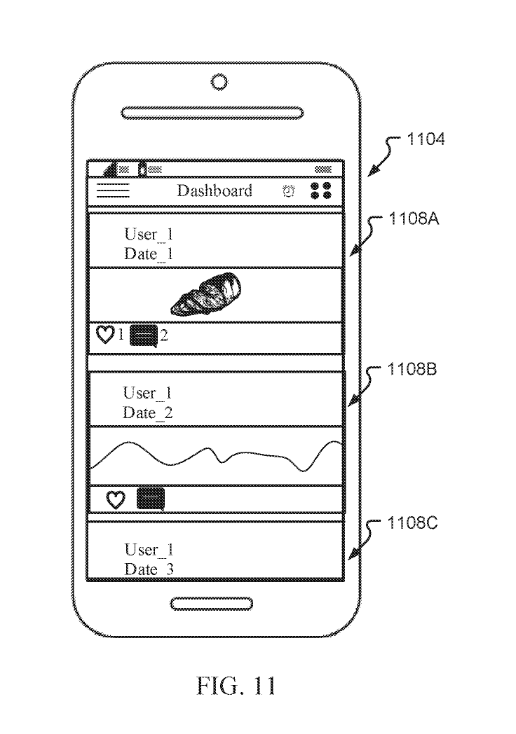

FIG. 11 depicts a fifth user interface display 1104 in accordance with embodiments of the present disclosure. That is, the fifth user interface display 1104 that may depict cooking sessions associated with the particular user utilizing the mobile device 504. For example, a first user cooking session display 1108A may be displayed indicating the user_name and/or user_profile, and a date at which the cooking session was made. The user cooking session display 1108A may further include a user provided image of the cooked item, as well as an area for likes as indicated by the heart and comments as indicated by the comment box. One or more of the user cooking session displays 1108A-C may be displayed. Upon selecting a user cooking session display 1108, additional detailed information from the selected cooking session may be displayed, as illustrated in sixth user interface display 1204, seventh user interface display 1208, and eighth user interface display 1212. That is, the sixth user interface display 1204 may display the cooking session display 1216 including the user_name and/or user_profile, the type and subtype of the food item cooked, how many people liked the cooking session, which may be made publicly available as a recipe, and any comments. Moreover, the sixth user interface display 1204 may display a user provided image 1220 of the food item, as well as cooking session sensor summary information 1224. The seventh user interface display 1208 and the eighth user interface display 1212 depict a scrolled interface of cooking session display 1216 such that cooking session sensor summary information 1224 and cooking session sensor summary information for another sensor for the same cooking session 1236 including the done temperature, the average ambient temperature (e.g., “air”), and the cooking time may be displayed. Further, sensor identification information 1228 and sensor identification information for another sensor for the same cooking session 1240 may be displayed. Further, the sensor graph 1232 and the sensor graph for another sensor of the same cooking session 1244 may be displayed. In some embodiments, the ghost profile 1248 may be displayed as well.

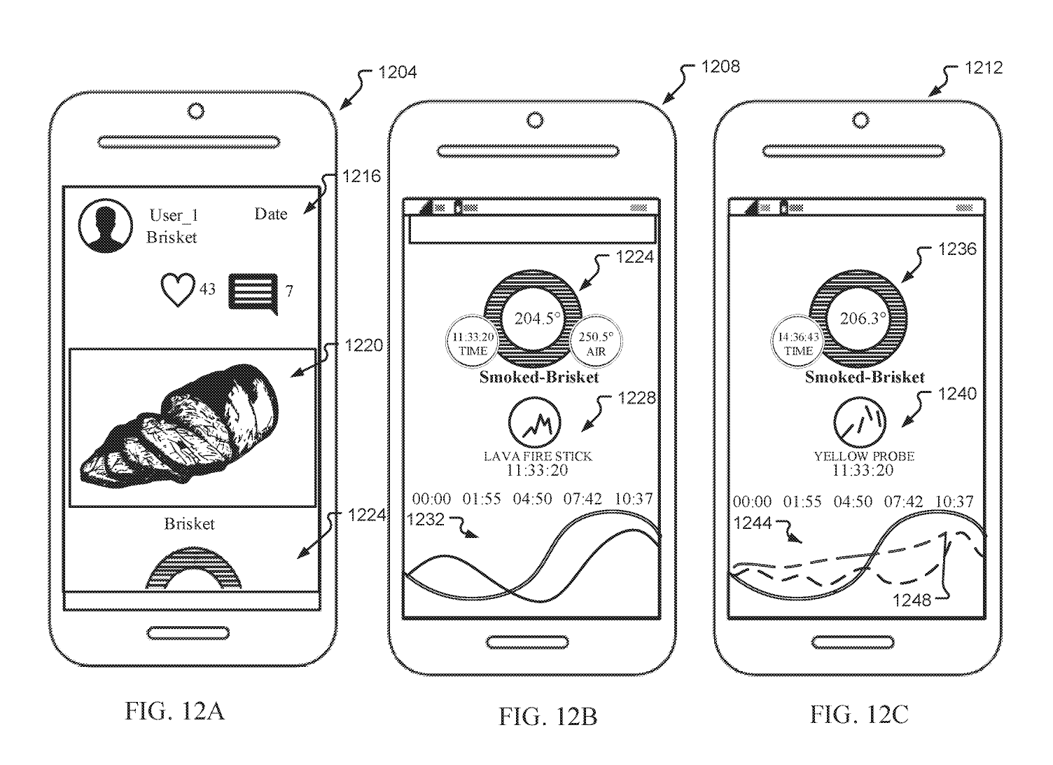

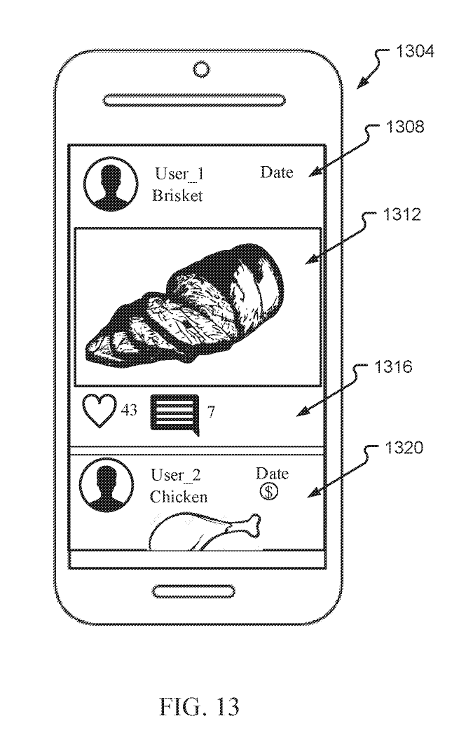

In accordance with embodiments of the present disclosure, FIG. 13 depicts a ninth user interface display 1304 illustrating one or more recipes and/or cooking sessions of other users. The other users may be followed by the user of the mobile device 504. For each of the recipes and/or cooking session, the user information 1308, user provided image 1312 (e.g., provided by the user associated with the one or more recipes and/or cooking sessions) and a comments/like section 1316 may be displayed. Moreover, for another user information section 1320 for another recipe and/or cooking session, a dollar sign ($) might be displayed, indicating that such cooking session and/or recipe is available for purchase. It should be appreciated that the information displayed in FIGS. 11-13 may be provided as cooking session information provided by the server 512 to the mobile device 504.

In accordance with embodiments of the present disclosure, an entity relationship diagram 1400 is depicted. That is, profile information 1404 including a PROFILE_ID of a user utilizing the mobile device 504 and the smart thermometer system 500 may be maintained at the server 512. The profile information 1404 may include items such as a user name, login information, account identification information, and additional location related information. The profile information 1404 may be linked to one or more post information 1408, and further post detail information 1412. The post detail information 1412 may be linked to a post type detail 1416, where the post type may be a recipe or a session, such as a cooking session. The recipe type post may include recipe detail 1420 while the session type post may include session detail 1424. Linked to each of the recipe detail 1420 and/or the session detail 1424, may be image information 1428 linked to image detail 1432. The post information 1408 may be linked to a comment information 1436 and/or to like information 1444. Thus, the comment information 1436 may be linked to comment detail information 1440. In instances where the user associated with the profile information 1404 follows other users, the profile information 1404 may be linked to following information 1448.

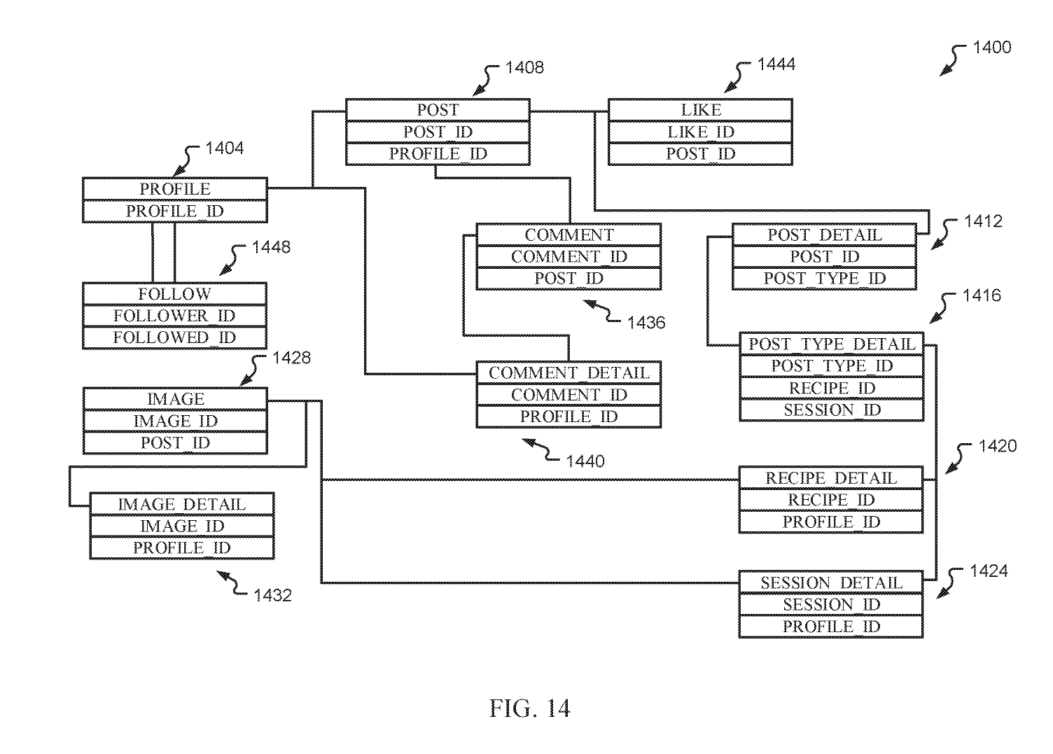

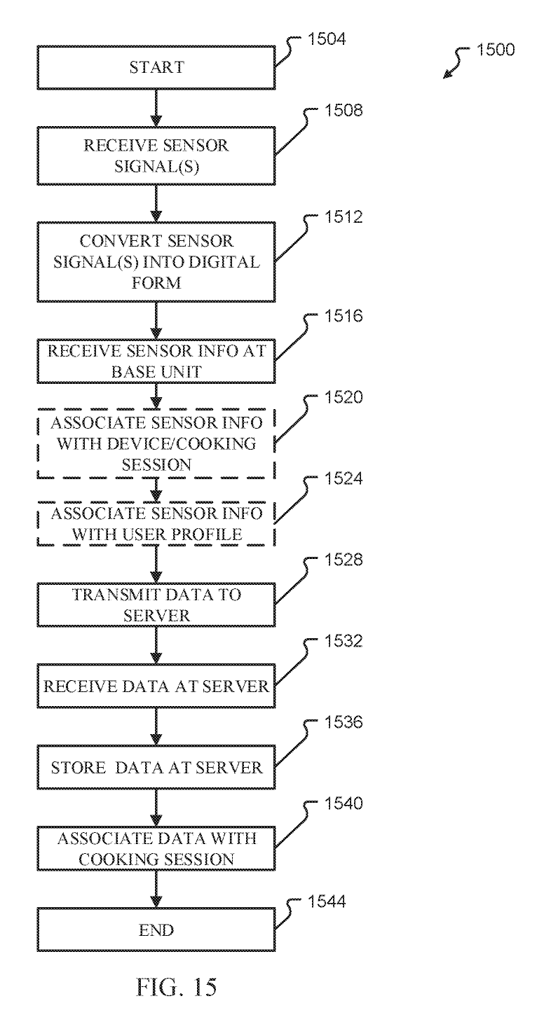

FIG. 15 depicts a method 1500 directed to obtaining sensor data and associating the sensor data with a cooking session in accordance with embodiments of the present disclosure. The method 1500 is in embodiments, performed by and/or in conjunction with one or more devices, such as one or more devices included in the smart thermometer system 500. More specifically, one or more hardware and software components may be involved in performing method 1500. In one embodiment, one or more of the previously described units, or devices, perform one or more of the steps of method 1500. The method 1500 may be executed as a set of computer-executable instructions executed by a mobile device, by a computing device, and/or by one or more components of the smart thermometer system 500. One or more portions of method 1500 may be encoded or stored on a computer-readable medium. Hereinafter, the method 1500 shall be explained with reference to systems, components, units, software, etc. described with FIGS. 1-14.

Method 1500 may be initiated at step 1504, where a base unit 104 may be turned on utilizing the user input receiving device 332 for example. At step 1508, the controller/logic circuit 344 may receive sensor information in the form of one or more of sensor information 708A-C. At step 1512, the sensor signals may be converted into digital sensor information 708 by the controller/logic circuit 344. The controller/logic circuit 344 may then provide the sensor information 708 to the base unit at step 1516. At step 1520, the base unit 104 may associate the sensor information 708 with a device identifier and/or user profile at step 1524, resulting in the assembled format and/or data structure 712. Either of step 1520 and/or step 1524 may be optionally performed. At step 1528, the base unit 104 may transmit the assembled format and/or data structure 712 to the server where the assembled format and/or data structure 712 is received at the server at step 1532. At step 1536, the server 512 may store the assembled format and/or data structure 712, for example in a database 616. At step 1540, the server 512 may associate the received sensor data with a cooking session. The method 1500 may end at step 1544.

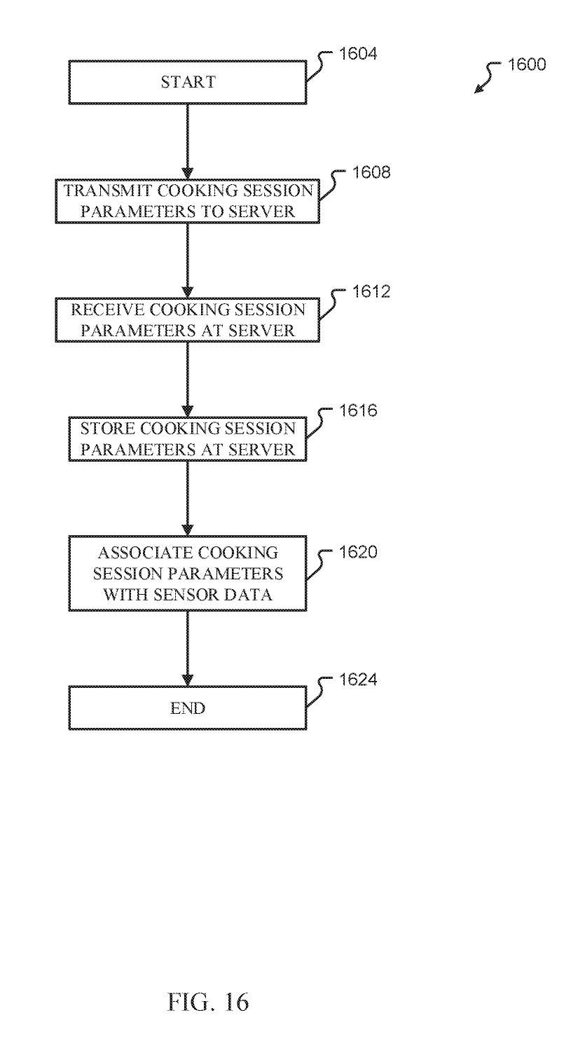

FIG. 16 depicts a method 1600 directed to providing cooking session parameters to the server 512 from the mobile device 504 in accordance with embodiments of the present disclosure. The method 1600 is in embodiments, performed by and/or in conjunction with one or more devices, such as one or more devices included in the smart thermometer system 500. More specifically, one or more hardware and software components may be involved in performing method 1600. In one embodiment, one or more of the previously described units, or devices, perform one or more of the steps of method 1600. The method 1600 may be executed as a set of computer-executable instructions executed by a mobile device, by a computing device, and/or by one or more components of the smart thermometer system 500. One or more portions of method 1600 may be encoded or stored on a computer-readable medium. Hereinafter, the method 1600 shall be explained with reference to systems, components, units, software, etc. described with FIGS. 1-15.

Method 1600 may be initiated at step 1604, where a user may enter one or more parameters as information that is received from the mobile device 804 by the server 512. At step 1608, the cooking session parameters, such as one or more of the data included in the information received from the mobile device 804, may be transmitted to the server 512. At step 1612, the server 512 may receive the transmitted one or more of the data included in the information received from the mobile device 804 and store such information at step 1616. At step 1620, the server 512 may associate the received information with the assembled format and/or data structure 712, which may have been received at step 1532. The method 1600 may end at step 1624.

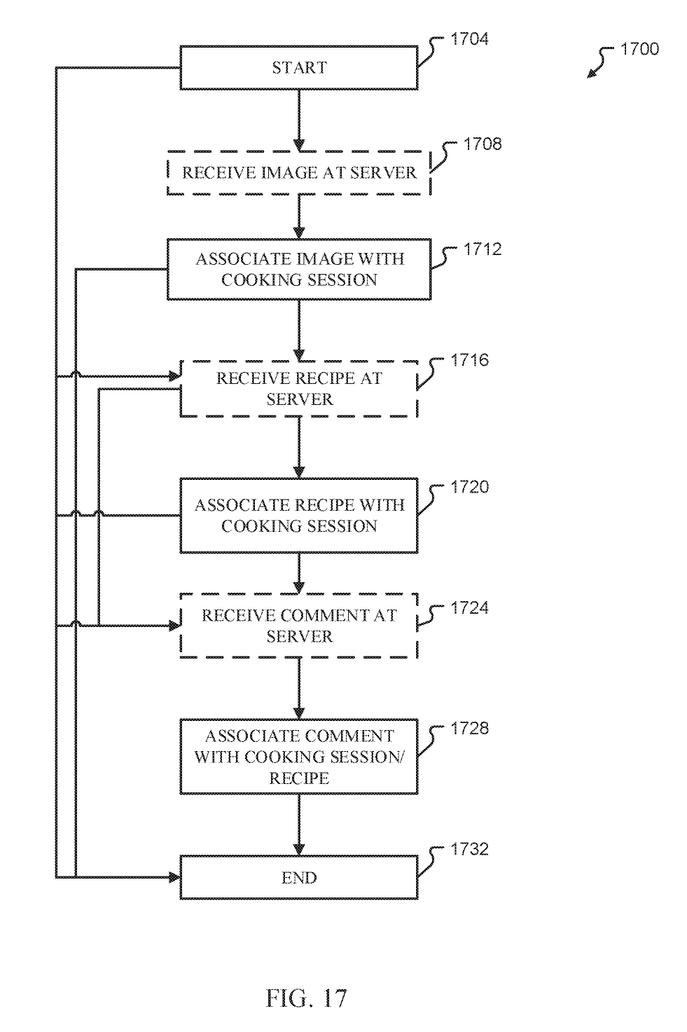

FIG. 17 depicts a method 1700 directed to associating one or more images, comments, and/or cooking session with a user profile. The method 1700 is in embodiments, performed by and/or in conjunction with one or more devices, such as one or more devices included in the smart thermometer system 500. More specifically, one or more hardware and software components may be involved in performing method 1700. In one embodiment, one or more of the previously described units, or devices, perform one or more of the steps of method 1700. The method 1700 may be executed as a set of computer-executable instructions executed by a mobile device, by a computing device, and/or by one or more components of the smart thermometer system 500. One or more portions of method 1700 may be encoded or stored on a computer-readable medium. Hereinafter, the method 1700 shall be explained with reference to systems, components, units, software, etc. described with FIGS. 1-16.

Method 1700 may be initiated at step 1704, where a user wishes to utilize an application (app) running on the mobile device 504 to provide an image of a food item, provide a recipe associated with a food item, and/or provide a comment related to a food item. At step 1708, the user may cause the app to acquire an image and provide the image to the server 512. At step 1712, the server 512 may then associate the received image with a specified cooking session, such as a cooking session ID. If step 1708 is not performed and/or if the user wishes to associate a recipe with a cooking session, the user may enter a recipe within the app and cause the app to transmit the recipe to the server at step 1716. At step 1720, the server 512 may associate the recipe with a cooking session. If steps 1708, and/or 1716 are not performed and/or if the user wishes to provide a comment related to a food item, the user may cause the app to acquire a comment at step 1724 and associate the comment with the cooking session and/or recipe at step 1728. The method 1700 may end at step 1732.

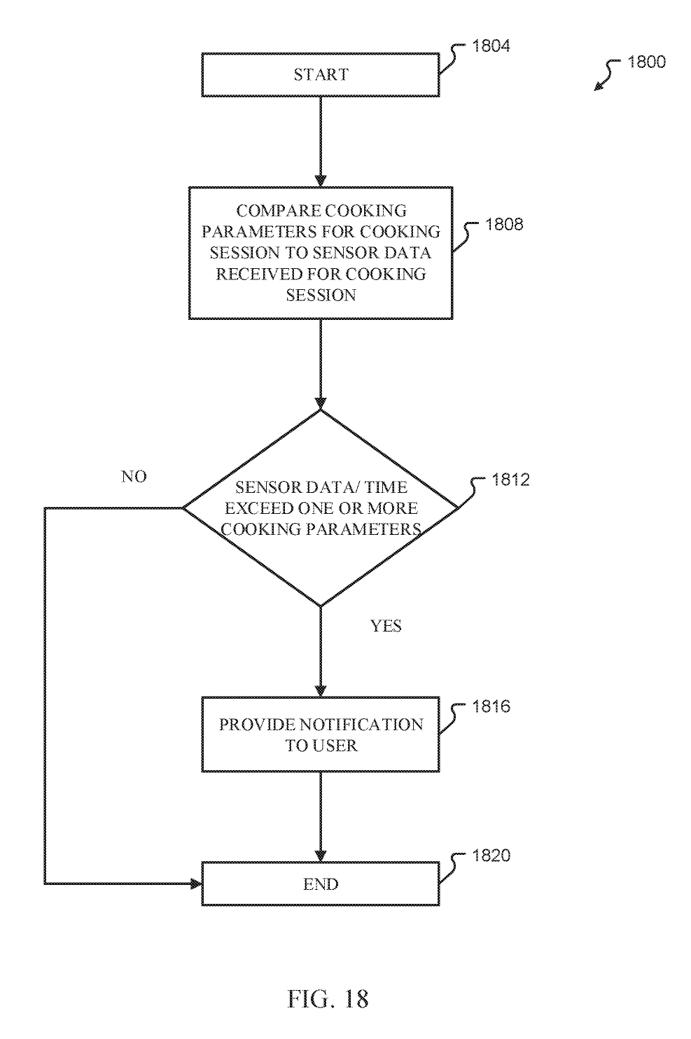

FIG. 18 depicts a method 1800 directed to determining if sensor information exceeds a specified cooking parameter. The method 1800 is in embodiments, performed by and/or in conjunction with one or more devices, such as one or more devices included in the smart thermometer system 500. More specifically, one or more hardware and software components may be involved in performing method 1800. In one embodiment, one or more of the previously described units, or devices, perform one or more of the steps of method 1800. The method 1800 may be executed as a set of computer-executable instructions executed by a mobile device, by a computing device, and/or by one or more components of the smart thermometer system 500. One or more portions of method 1800 may be encoded or stored on a computer-readable medium. Hereinafter, the method 1800 shall be explained with reference to systems, components, units, software, etc. described with FIGS. 1-17.

Method 1800 may be initiated at step 1804, where it may be initiated according to a timed event and/or at a predetermined time period. At step 1808, the server 512 may compare one or more cooking parameters to sensor data received from the base unit 104 and stored at the server 512. The cooking parameters may be provided at the third user interface 1012 for example and may be associated with a cooking session. At step 1812, if the sensor data exceeds one or more cooking parameters, the server 512 may provide a notification at step 1816, such as a push notification, email notification, or cause the app running at the mobile device 504 to enter an alarm condition. Alternatively, or in addition, the method 1800 may end at step 1820.

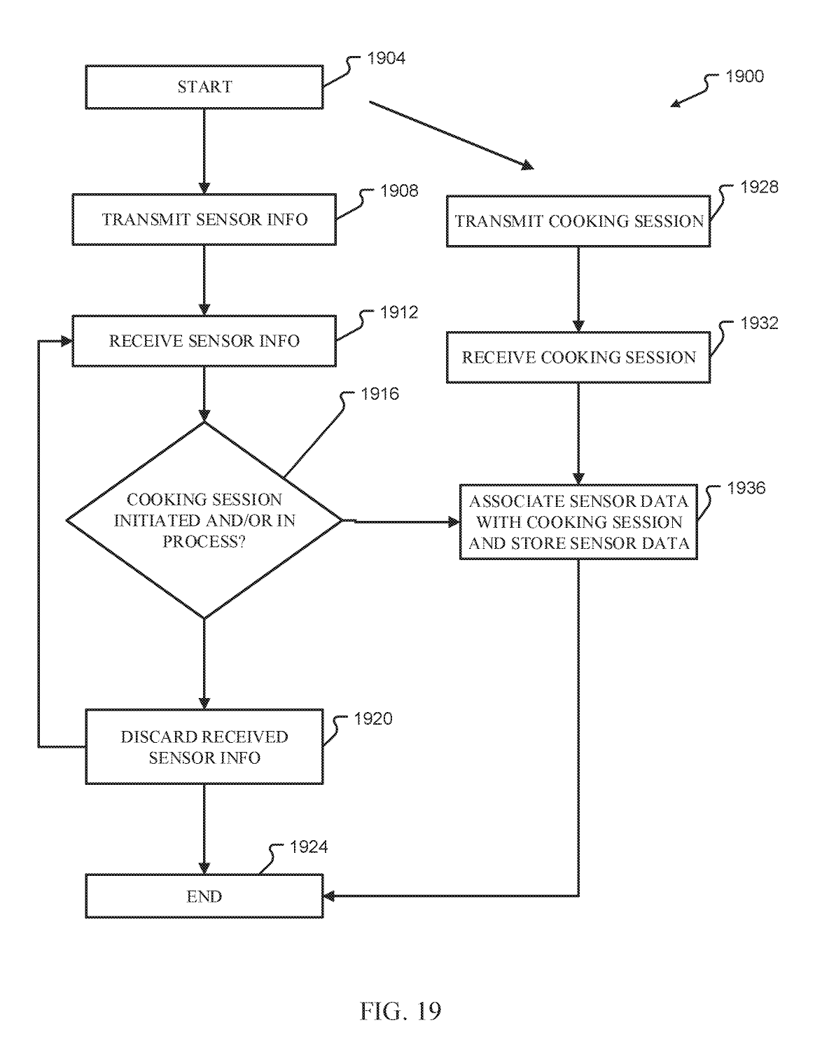

FIG. 19 depicts a method 1900 directed to providing sensor information from the base unit 104 to the server 512 and associating the sensor information to a cooking session provided by the mobile device 504. The method 1900 is in embodiments, performed by and/or in conjunction with one or more devices, such as one or more devices included in the smart thermometer system 500. More specifically, one or more hardware and software components may be involved in performing method 1900. In one embodiment, one or more of the previously described units, or devices, perform one or more of the steps of method 1900. The method 1900 may be executed as a set of computer-executable instructions executed by a mobile device, by a computing device, and/or by one or more components of the smart thermometer system 500. One or more portions of method 1900 may be encoded or stored on a computer-readable medium. Hereinafter, the method 1900 shall be explained with reference to systems, components, units, software, etc. described with FIGS. 1-18.

Method 1900 may be initiated at step 1904, where a user may cause the base unit 104 to turn on utilizing the user input receiving device 332. Alternatively, or in addition, the method 1900 may be initiated when a user launches the app and starts a new cooking session. Accordingly, the method 1900 may proceed to step 1908. Step 1908 may include one or more steps 1504-1524 of method 1500. Accordingly, at step 1912, the sensor info may be received at the server 512. At step 1916, the server 512 may determine whether or not a cooking session has been initiated and/or is currently in process. If a cooking session is not currently in process or has yet to be received, then the sensor info is discarded by the server at step 1920. Method 1900 may then end at step 1924. If, however, a cooking session has been initiated and/or is in process, the sensor info may be associated with the cooking session at step 1936. Accordingly, steps 1928, 1932, and 1936 may encompass steps 1604-1620 of method 1600. That is, steps 1928 and 1932 may be run in parallel to steps 1908 and 1912. Method 1900 may then end at step 1924.

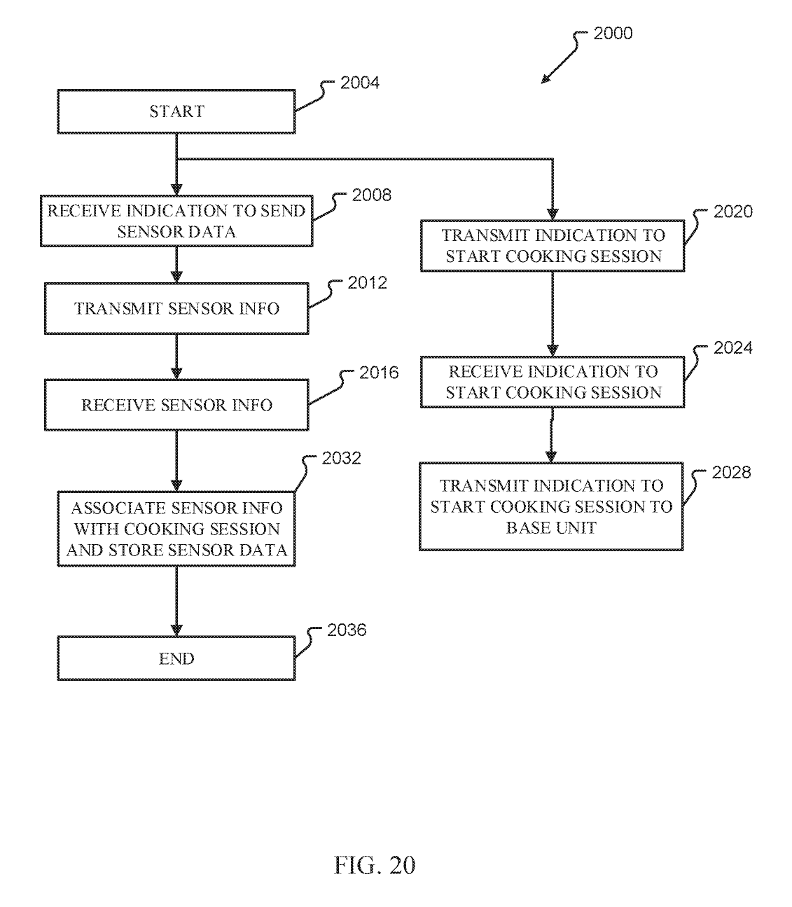

FIG. 20 depicts a method 2000 directed to providing sensor information from the base unit 104 to the server 512 and associating the sensor information to a cooking session provided by the mobile device 504. The method 2000 is in embodiments, performed by and/or in conjunction with one or more devices, such as one or more devices included in the smart thermometer system 500. More specifically, one or more hardware and software components may be involved in performing method 2000. In one embodiment, one or more of the previously described units, or devices, perform one or more of the steps of method 2000. The method 2000 may be executed as a set of computer-executable instructions executed by a mobile device, by a computing device, and/or by one or more components of the smart thermometer system 500. One or more portions of method 2000 may be encoded or stored on a computer-readable medium. Hereinafter, the method 2000 shall be explained with reference to systems, components, units, software, etc. described with FIGS. 1-19.

Method 2000 may be initiated at step 2004, where a user may cause the base unit 104 to turn on utilizing the user input receiving device 332. Alternatively, or in addition, the method 2000 may be initiated when a user launches the app and starts a new cooking session. Accordingly, at step 2020, an indication to start a cooking session may be sent from the mobile device 504 to the server 512. For example, the information may be included in the assembled format and/or data structure 712. Accordingly, the method 2000 may proceed to step 2024 where the start/stop indication and/or Session_ID 716 is received at the server 512. Accordingly, at step 2008, the server 512 may transmit a start/stop indication and/or Session_ID 716 to the base unit 104. Accordingly, step 2012 through step 2016 may encompass steps 1508 through 1536 of method 1500. At step 2032, the server 512 may associate the received sensor info (assembled format and/or data structure 712) to one or more parameters included in the data received from the server 804. Moreover, in some embodiments, steps 2020 may include steps 1604 to step 1616 of method 1600. Method 2000 may then end at step 2036.

Embodiments in accordance with the present disclosure may be directed to a temperature monitoring system including a sensor assembly that includes a probe, a cable portion, a probe plug, and a logic controller, where the logic controller is configured to receive a signal indicative of a temperature of a food item and convert the signal into a digital representation. The cable portion may be between the probe plug and the logic controller. The base unit may include a sensor interface removeably and communicatively coupled to the probe plug, and a controller. The controller may be configured to receive the digital representation from the logic controller via the sensor interface, where the base unit is configured to transmit the digital representation to a receiving entity.

Aspects of the above embodiment may include where the probe includes a first sensor portion and a second sensor portion, the first sensor portion providing the signal indicative of the temperature of the food item to the logic controller and the second sensor portion providing a signal indicative of an ambient air temperature to the logic controller. Additional aspects of the above embodiment may include where the base unit includes a magnet at a bottom side thereof. Additional aspects of the above embodiment may include where the base unit includes a light configured to indicate an operating state of the base unit. Additional aspects of the above embodiment may include where the base unit is configured to transmit a device identifier together with the digital representation to the receiving entity. Additional aspects of the above embodiment may include where the probe includes a first sensor portion and a second sensor portion, the first sensor portion providing the signal indicative of the temperature of the food item to the logic controller and the second sensor portion providing a signal indicative of an ambient air temperature to the logic controller. Additional aspects of the above embodiment may include where the logic controller is configured to receive the signal indicative of the ambient air temperature and convert the signal indicative of the ambient air temperature into a digital representation. Additional aspects of the above embodiment may include where the controller is configured to receive the digital representation of the signal indicative of the ambient air temperature from the logic controller via the sensor interface, and wherein the base unit is configured to transmit the digital representation of the signal indicative of the ambient air temperature to the receiving entity. Additional aspects of the above embodiment may include where the controller is configured to receive a probe identifier from the logic controller and the base unit is configured to transmit the probe identifier to the receiving entity. Additional aspects of the above embodiment may include a mobile device configured to receiving temperature information of the food item and the ambient air temperature from the receiving entity.

Embodiments in accordance with the present disclosure may be directed to a temperature monitoring system including a sensor assembly. The sensor assembly may include a probe, a cable portion, a probe plug, and a logic controller, the logic controller configured to receive a signal indicative of a temperature of a food item and convert the signal into a digital representation. The cable portion may be between the probe plug and the logic controller. The base unit may include a sensor interface removeably and communicatively coupled to the probe plug, and a controller, the controller configured to receive the digital representation from the logic controller via the sensor interface. The temperature monitoring system may include a remotely located computer-based entity configured to receive the digital representation from the logic controller and associate the received digital representation to a cooking session identifier.

Aspects of the above embodiment may include where the cooking session identifier is received from a remotely located mobile device. Additional aspects of the above embodiment may include where the cooking session identifier is provided based on an indication receive from a remotely located mobile device. Additional aspects of the above embodiment may include where the remotely located computer-based entity is configured to provide a value indicative of the digital representation to a remotely located mobile device. Additional aspects of the above embodiment may include where the remotely located computer-based entity is configured to provide an alert to the remotely located mobile device when the digital representation is greater than a threshold. Additional aspects of the above embodiment may include where the threshold is received from the remotely located mobile device. Additional aspects of the above embodiment may include where the remotely located mobile device communicates with the remotely located computer-based entity via a first wireless network and the base unit communicates with the remotely located computer-based entity via a second wireless network. Additional aspects of the above embodiment may include where the remotely located computer-based entity is not in direct communication with the remotely located mobile device.

Embodiments in accordance with the present disclosure may be directed to a method for associating temperature data with a cooking session, the method including: receiving from a base unit, a digital representation of a temperature associated with a food item, storing the digital representation, receiving from a remotely located mobile device, an indication to start a cooking session, creating a new cooking session identifier, and associating the digital representation of the temperature associated with the food item with the new cooking session identifier.

Aspects of the above embodiment may include transmitting to the base unit, the new cooking session identifier.

Embodiments and aspects may include a computer-implemented method comprising: receiving, by a computer system, an image of a food item, wherein the image is associated with a first user profile and/or a first cooking session; maintaining, by the computer system, first sensor information about the food item; receiving, by the computer system, textual information associated with a second user profile; and associating the textual information associated with the second user profile with the image of the food item. The above computer-implemented method, further comprising: receiving the first sensor information about the food item; and associating, by the computer system, the first sensor information with the first user profile and/or the first cooking session. One or more of the above computer-implemented methods, further comprising: receiving, by the computer system, a second image of a food item, wherein the second image is associated with the second user profile and/or a second cooking session. One or more of the above computer-implemented methods, further comprising: receiving, by the computer system, another image of a second food item; receiving, by the computer system, second sensor information; and associating, by the computer system, the second sensor information with the first user profile and/or a second cooking session. One or more of the above computer-implemented methods, wherein the sensor information includes temperature information for the food item while the food item is cooking. One or more of the above computer-implemented methods, wherein the sensor information includes ambient temperature information. One or more of the above computer-implemented methods, wherein the second sensor information includes temperature information for the second food item while the second food item is cooking. One or more of the above computer-implemented methods, further comprising: providing, by the computer system, the textual information and the image of the food item to a remotely situated mobile computing device.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A temperature monitoring system comprising:
a sensor assembly including:
a probe,
a cable portion,
a probe plug, and
a logic controller, the logic controller configured to receive a signal indicative of a temperature of a food item and convert the signal into a digital representation, wherein the cable portion is between the probe plug and the logic controller; and
a base unit including:
a sensor interface removeably and communicatively coupled to the probe plug, and
a controller, the controller configured to receive the digital representation from the logic controller via the sensor interface,
wherein the base unit is configured to transmit the digital representation to a receiving entity.

2. The temperature monitoring system according to claim 1, wherein the probe includes a first sensor portion and a second sensor portion, the first sensor portion providing the signal indicative of the temperature of the food item to the logic controller and the second sensor portion providing a signal indicative of an ambient air temperature to the logic controller.

3. The temperature monitoring system according to claim 3, wherein the base unit includes a magnet at a bottom side thereof.

4. The temperature monitoring system according to claim 1, wherein the base unit includes a light configured to indicate an operating state of the base unit.

5. The temperature monitoring system according to claim 1, wherein the base unit is configured to transmit a device identifier together with the digital representation to the receiving entity.

6. The temperature monitoring system according to claim 5, wherein the probe includes a first sensor portion and a second sensor portion, the first sensor portion providing the signal indicative of the temperature of the food item to the logic controller and the second sensor portion providing a signal indicative of an ambient air temperature to the logic controller.

7. The temperature monitoring system according to claim 6, wherein the logic controller is configured to receive the signal indicative of the ambient air temperature and convert the signal indicative of the ambient air temperature into a digital representation.

8. The temperature monitoring system according to claim 7, wherein the controller is configured to receive the digital representation of the signal indicative of the ambient air temperature from the logic controller via the sensor interface, and wherein the base unit is configured to transmit the digital representation of the signal indicative of the ambient air temperature to the receiving entity.

9. The temperature monitoring system according to claim 8, wherein the controller is configured to receive a probe identifier from the logic controller and the base unit is configured to transmit the probe identifier to the receiving entity.

10. The temperature monitoring system according to claim 1, further comprising a mobile device configured to receiving temperature information of the food item and the ambient air temperature from the receiving entity.

11. A temperature monitoring system comprising:
a sensor assembly including:
a probe,
a cable portion,
a probe plug, and
a logic controller, the logic controller configured to receive a signal indicative of a temperature of a food item and convert the signal into a digital representation, wherein the cable portion is between the probe plug and the logic controller;
a base unit including:
a sensor interface removeably and communicatively coupled to the probe plug, and
a controller, the controller configured to receive the digital representation from the logic controller via the sensor interface; and
a remotely located computer-based entity configured to receive the digital representation from the logic controller and associate the received digital representation to a cooking session identifier.

12. The temperature monitoring system according to claim 11, wherein the cooking session identifier is received from a remotely located mobile device.

13. The temperature monitoring system according to claim 11, wherein the cooking session identifier is provided based on an indication receive from a remotely located mobile device.

14. The temperature monitoring system according to claim 11, wherein the remotely located computer-based entity is configured to provide a value indicative of the digital representation to a remotely located mobile device.

15. The temperature monitoring system according to claim 14, wherein the remotely located computer-based entity is configured to provide an alert to the remotely located mobile device when the digital representation is greater than a threshold.

16. The temperature monitoring system according to claim 15, wherein the threshold is received from the remotely located mobile device.

17. The temperature monitoring system according to claim 14, wherein the remotely located mobile device communicates with the remotely located computer-based entity via a first wireless network and the base unit communicates with the remotely located computer-based entity via a second wireless network.

18. The temperature monitoring system according to claim 17, wherein the remotely located computer-based entity is not in direct communication with the remotely located mobile device.

19. A method for associating temperature data with a cooking session, the method comprising:
receiving from a base unit, a digital representation of a temperature associated with a food item;
storing the digital representation;
receiving from a remotely located mobile device, an indication to start a cooking session;
creating a new cooking session identifier; and
associating the digital representation of the temperature associated with the food item with the new cooking session identifier.

20. The method according to claim 19, further comprising:
transmitting to the base unit, the new cooking session identifier.
